(19) United States
(12) Patent Application Publication
(10) Pub. No.: US 2012/0090383 A1
(43) Pub. Date: Apr. 19, 2012

(54) SYSTEM AND METHOD FOR DETECTING A REFRIGERANT LEAK AND CHEMICALS PRODUCED AS A RESULT OF HEATING OF THE REFRIGERANT

(76) Inventors: Audra Lopez, Albuquerque, NM (US); Eric Lopez, Albuquerque, NM (US)

(21) Appl. No.: 13/110,546

(22) Filed: May 18, 2011

Related U.S. Application Data
(60) Provisional application No. 61/393,096, filed on Oct. 14, 2010.

(51) Int. Cl. G01M 3/20

(52) U.S. Cl. 73/40.7

(57) ABSTRACT

A system and method for detecting leakage of a refrigerant and chemicals in an air conditioning and heating system. In some cases, a refrigerant may be inadvertently heated via a heating unit to produces dangerous chemicals. A detector can be installed near an air ventilator and can be utilized for detecting the leakage of refrigerant and chemicals that are dispersed in air by a ventilating system.

### CROSS-REFERENCE TO PROVISIONAL APPLICATION

This patent application claims the benefit under 35 U.S.C. §119(e) of U.S. Provisional Application Ser. No. 61/393,096 entitled, “System and Method for Detecting a Refrigerant Leak and Chemicals Produced as a Result of Heating of the Refrigerant,” which was filed on Oct. 14, 2010 and is incorporated herein by reference in its entirety.

### TECHNICAL FIELD

Embodiments are generally related to refrigerant detectors. Embodiments also relate to the field of refrigerant detectors for air conditioning and heating systems utilized in homes and buildings. Embodiments additionally relate to techniques and systems for detecting the leakage of refrigerants and other chemicals produced during the use of refrigerants in devices such as air conditioners, refrigerators, and so forth.

### BACKGROUND OF THE INVENTION

Refrigerant is a substance used in Refrigeration and Air-Conditioning (RAC) systems and Heating, Ventilation and Air Conditioning (HVAC-R) systems for transferring heat from one place to other. Refrigerant absorbs heat by changing state (evaporating) from liquid to gas and releases heat by changing state (condensing) from gas back to liquid. An air conditioning system does not consume refrigerant, but reuses it. As long as there are no leaks in the refrigerant circuit, there is no need to add refrigerant to the air conditioning system.

Detection of a refrigerant leak in system, for example, HVAC-R is extremely difficult, even for the most experienced service technician. The leak can be well hidden from view in tubing, a system component, or in a safety control or operating switch. Various types of testing equipment, for example, piezoelectric smoke detector, ionization smoke detector, home smoke detector, and electronic leak detector are utilized in air conditioning system for detecting refrigerant leak. To find the leak, the service technicians have to determine the best method to use. The methods include a soap solution, a halide torch, dye interception, isolation of a component from the system, or pressurizing the system with dry nitrogen gas.

An electronic leak detector is one of the fastest methods used in refrigerant leak detection. These types of detectors can find leaks of Hydro fluorocarbons (HFCs) and Chlorofluorocarbons (CFCs). Typical examples of refrigerants used in heating and air conditioning system include ammonia, carbon dioxide gas, CFC gases, that is fluorine-containing carbonized compounds referred as Freon gases such as R-11, R-12, R-13, R-21, R-22, R-113, R-114, R-500 and R-502, propane, etc. Quick identification of a refrigerant leak is important because the United States Environmental Protection Agency (EPA) heavily regulates the release of refrigerant with companies subject to fines if their emissions are not fixed within a certain timeframe.

In one prior art, a refrigerant leak detection apparatus and method for testing for leaking refrigerant within a heat exchanging fluid, particularly for testing for leaking refrigerant in a chiller system comprising heat exchangers is disclosed.

In another prior art example, a photoelectric smoke detector can be utilized to detect the presence of smoke by employing a light emitting element and a light-receiving element whose optical axes intersect with each other. The photoelectric smoke detector may include a casing for storing the light emitting element and the light-receiving element. Inlet and outlet ports may be respectively provided in one and the other side of the casing, the inlet and outlet ports bringing air flow into the casing. Rectifying light blocking means may be provided contiguously with each of the inlet and outlet ports. The rectifying light blocking means prevents the entry of disturbance light into an interior space and forms a flow line of smoke extending from one or the other inlet and outlet port to the other or the one inlet and outlet port such that the flow line passes through a detection area by the light emitting element and the light receiving element.

In another prior art example, a hydrogen sensor can be protected from water vapor by a membrane that indicates increases in hydrogen concentrations, which are indicative of a leak in an absorption chiller. A helium detector, protected from water vapor and liquid water by a membrane and a vapor trap, senses the presence of helium from a spray to locate the position of leaks. A hydrogen-removing cell can be tested by monitoring the variation with time of the hydrogen concentration before and after the cell is rendered inoperative.

A sensor for sensing the quantity of refrigerant in a closed loop refrigeration system with the sensor having attachment means on a lower portion thereof such that it may be installed in direct communication with the refrigerant line of the refrigeration system is disclosed in another prior art. The sensor has a hollow interior portion defined by generally cylindrical sidewalls, in which the interior portion a float of conductive material is disposed with the float being free to rise on the surface of liquid refrigerant entering the interior of the sensor from the refrigerant line. One or more electrodes may be disposed in the interior of the sensor in a position such that the float will contact it at the time a certain refrigerant level is reached in the interior of the sensor. The electrode forms a part of an electrical circuit configured and arranged to perform a specific control function with such electrical circuit being completed to perform that control function at the time the certain refrigerant level is reached, this being as a consequence of electrical contact of the float with the electrode. The control function can include providing of an alarm to the operator of the system, or the automatic addition of refrigerant to the system as needed, and in controlled amounts.

The leakage of refrigerant can be a life threatening and dangerous condition, particularly in homes where families live. The refrigerant can be heated, for example, by an internal coil of a heating unit in an air conditioning system such as dual pack type air conditioning and heating system. For example, Freon may heat and produce the bi-products that can include, for example, chemicals such as hydrochloric acid and phosgene, which are very dangerous. In such a system, leaked refrigerant and chemicals can be dispersed or “burned” inside a home, therefore polluting the home.

The prior refrigerant detectors detect and prevent only the refrigerant leak and not the chemicals produced during heating of the refrigerant. The chemicals are highly toxic and insidious poisons as odor may not be noticed and symptoms may be slow to appear. The chemicals may affect the human pulmonary alveoli and disrupts the blood-air barrier causing suffocation. Hence, the knowledge of chemicals dispersed in the air as a result of the refrigerant leakage is also needed. In an effort to address the foregoing difficulties, it is believed that the ability to effectively detect the refrigerant and chemical leak as discussed herein can address many of the problems with traditional leak detection methods and systems.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a refrigerant detector.

It is another aspect of the disclosed embodiments to provide for a refrigerant detector for air conditioning and heating system utilized in homes and buildings.

It is a further aspect of the present invention to provide for a system and method for detecting leakage of refrigerant and chemicals produced during heating refrigerant.

The aforementioned aspects and other objectives and advantages can now be achieved as described herein. A system and method for detecting leakage of a refrigerant and chemicals in an air-conditioning system, for example, dual pack heating and air conditioning system is disclosed. The refrigerant can be heated, for example, by an internal coil of a heating unit of an air conditioning system and may produce dangerous chemicals. The refrigerant and chemicals may disperse in air by a ventilating system. A detector can be installed in a suitable location and can be utilized for detecting the leakage of the refrigerant and chemicals.

### BRIEF DESCRIPTION OF THE DRAWINGS

The accompanying figures, in which like reference numerals refer to identical or functionally similar elements throughout the separate views and which are incorporated in and form a part of the specification, further illustrate the disclosed embodiments and, together with the detailed description of the invention, serve to explain the principles of the disclosed embodiments.

FIG. 1 illustrates a simplified block diagram of an air conditioning system, in accordance with the disclosed embodiments;

FIG. 2 illustrates a schematic diagram of an air conditioning system with a refrigerant leak, in accordance with the disclosed embodiments; and

FIG. 3 illustrates a high level flow chart depicting the process of detecting refrigerant leak and chemicals, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

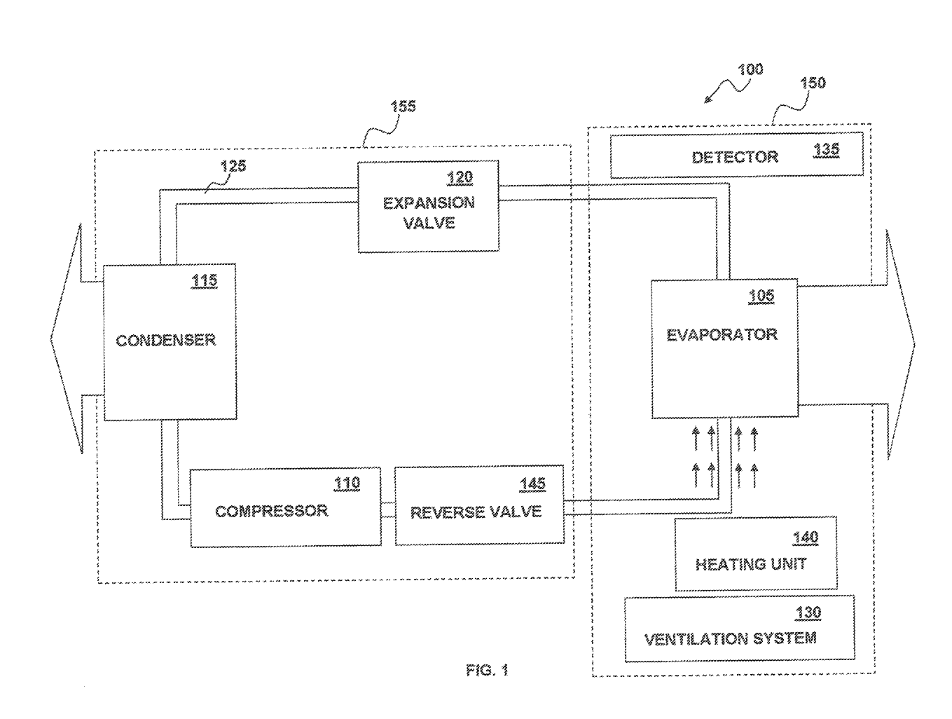

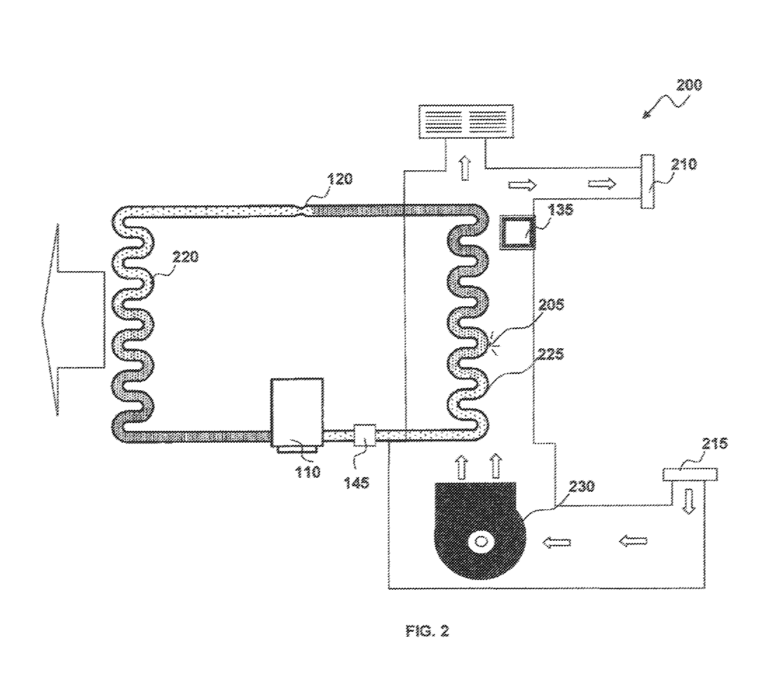

FIG. 1 illustrates a simplified block diagram of an air conditioning and/or heating system 100, in accordance with the disclosed embodiments. Note that in FIGS. 1-2, identical or similar parts or elements are generally indicated by identical reference numerals. The system 100 can be operated either in a cooling cycle or heating cycle depending upon the requirement such as for cooling or heating the building (not shown) respectively. An evaporator 105, a heating unit 140, a ventilation system 130, and a detector 135 are usually located on an indoor unit 150 of a house or building (not shown). The outdoor unit 155 includes a compressor 110, a condenser 115, a reverse valve 145, and an expansion valve 120. The system 100 can be operated either in a cooling cycle or heating cycle depending upon the requirement such as for cooling or heating the building (not shown) respectively.

In a cooling cycle, the refrigerant 125 arrives at the compressor 110 as a cool, low-pressure gas. The compressor 110 squeezes the refrigerant 125 and packs the molecules closer together. The hot, high-pressure refrigerant 125 gas from the compressor 110 flows into the condenser 115. In the condenser 115, the refrigerant 125 heat is exchanged with the surrounding air and thus hot, high pressure gas is converted to hot, high pressure liquid. Then, the expansion valve 120 converts the refrigerant 125 to cool, low-pressure liquid. In the evaporator 105, the liquid evaporates and leaves as cool, low-pressure gas. The cool refrigerant 125 is utilized for cooling the building (not shown) by exchanging cool refrigerant with the surrounding air.

FIG. 2 illustrates a schematic diagram of an air conditioning and heating system 200 with a refrigerant leak, in accordance with the disclosed embodiments. In a heating cycle, a reverse valve 145 is operated to reverse the flow of refrigerant 125. Hot, high-pressure gas is converted to hot, high-pressure liquid in an inside coil 225. The hot gas is exchanged with the surrounding air and utilized for heating the building (not shown). Then, the hot, high-pressure liquid is expanded in expansion valve 120 and converted to cool, low-pressure liquid. In an outside coil 220, the cool, low pressure liquid 125 is converted to cool, low-pressure gas after exchanging the cool refrigerant 125 with the surrounding air. Then, in compressor 110 the low-pressure gas is converted to high-pressure gas and the process continues until the required temperature is reached. The inside coil 225 can function either as an evaporator or condenser depending upon a heating or cooling cycle. For example, the inside coil 225 may function as an evaporator during the cooling cycle and may function as a condenser during a heating cycle. Also, the external or “outside” coil 220 may function either as an evaporator or condenser depending upon a heating or cooling cycle. For example, the outside coil 220 may function as a condenser in cooling cycle and may function as an evaporator in heating cycle.

The refrigerant 125, for example, Freon, inside coil 225 having a leak at 205, can be heated by the heating unit 140 depicted in FIG. 1 via, for example, a furnace 230. The by-product of the heating refrigerant can include, for example, chemicals such as chlorine, hydrochloric acid, and phosgene, which are very dangerous. The chemicals can be dispersed or burned into a building (not shown) through the ventilation system 130 of FIG. 1. A small portable detector 135 can be placed in a convenient location such as, for example, near air vents 210 and 215 in the home or building (not shown) for detecting such leakage of refrigerant and chemicals. The detection of a refrigerant and chemical leak may avoid life threatening and dangerous conditions, particularly in homes where families live.

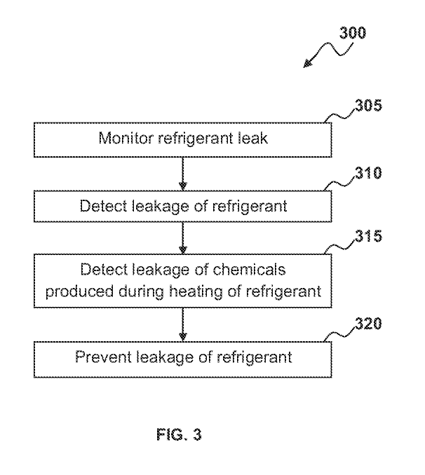

FIG. 3 illustrates a high level flow chart of operations depicting a method 300 of detecting a refrigerant and chemical leak, in accordance with the embodiments. As depicted at block 305, the system 100 of FIG. 1 can be utilized for monitoring the refrigerant leak. Then, as indicated at block 310, the refrigerant leak in the inside coil 225 depicted in FIG. 2 can be detected. The chemicals produced during heating of a refrigerant are detected as illustrated at block 315. Finally, as depicted at block 320, the refrigerant leak can be prevented and fixed.

Based on the foregoing, it can be appreciated that varying embodiments may be implemented. For example, in one embodiment a system can be implemented for detecting a leakage of a refrigerant and/or one or more chemicals in an air conditioning and heating system. Such a system can comprise a detector for detecting the leakage of the refrigerant and/or one or more chemicals dispersed in air, wherein the refrigerant may be heated by a heating unit to produce the chemical(s). That is, the chemical(s) are a byproduct of the refrigerant when the refrigerant is heated. The leakage of the refrigerant can occur via an inside coil of the air conditioning and heating system. The leakage of the refrigerant and any byproduct chemical(s) thereof can be dispersed in air via a ventilation system, which is why it is important to be able to detect such a leakage. The detector can be installed proximate to an air ventilator of the ventilation system. The heating unit may be of the type utilized for heating a building. The air conditioning and heating system may be, for example, a “dual pack” type heating and cooling unit.

In another embodiment, the detector can detect the leakage of the refrigerant and/or the chemical(s) dispersed in air, wherein the refrigerant may be accidentally heated by a heating unit to produce the chemical(s) and wherein the leakage of the refrigerant occurs via an inside coil of the air conditioning and heating system. Again, the leakage of the refrigerant and the chemical(s) may be dispersed in air via a ventilation system.

In still another embodiment, a system for detecting a leakage of a refrigerant and/or the chemical(s) in an air conditioning and heating system can be implemented. Such a system may include in some embodiments a heating unit that interacts with an evaporator and a ventilation system, along with a condenser that interacts with an expansion valve and a compressor and a reverse valve. In such a system, a detector can be provided for detecting the leakage of the refrigerant and/or the chemical(s) dispersed in air through the ventilation system, wherein the refrigerant may be accidentally heated by a heating unit to produce the chemical(s). The detector can be positioned at a location proximate to the heating unit and the ventilation system.

Of course, as indicate previously if the refrigerant leaks and is accidentally heated, a byproduct may be a chemical such as chlorine, hydrochloric acid or phosgene. Detection of these chemicals is critical because such chemicals can be dispersed through the ventilation system and harm humans and be absorbed into porous materials such as walls, carpets, furniture, etc.

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A system for detecting a leakage of a refrigerant and/or at least one chemical in an air conditioning and heating system, said system comprising:
a detector for detecting said leakage of said refrigerant and/or said at least one chemical dispersed in air, wherein said refrigerant may be heated by a heating unit to produce said at least one chemical.

2. The system of claim 1 wherein said leakage of said refrigerant occurs via an inside coil of said air conditioning and heating system.

3. The system of claim 1 wherein said leakage of said refrigerant and said at least one chemical are dispersed in air via a ventilation system.

4. The system of claim 1 wherein said detector is installed proximate to an air ventilator of said ventilation system.

5. The system of claim 1 wherein said heating unit is utilized for heating a building.

6. The system of claim 1 wherein:
said leakage of said refrigerant occurs via an inside coil of said air conditioning and heating system; and
said leakage of said refrigerant and said at least one chemical are dispersed in air via a ventilation system.

7. The system of claim 6 wherein said detector is installed proximate to an air ventilator of said ventilation system.

8. The system of claim 5 wherein:
said leakage of said refrigerant occurs via an inside coil of said air conditioning and heating system; and
said leakage of said refrigerant and said at least one chemical are dispersed in air via a ventilation system.

9. The system of claim 8 wherein said detector is installed proximate to an air ventilator of said ventilation system.

10. A system for detecting a leakage of a refrigerant and/or at east one chemical n an air conditioning and heating system, said system comprising:
a detector for detecting said leakage of said refrigerant and/or said at least one chemical dispersed in air, wherein said refrigerant may be accidentally heated by a heating unit to produce said at least one chemical and wherein said leakage of said refrigerant occurs via an inside coil of said air conditioning and heating system.

11. The system of claim 10 wherein said leakage of said refrigerant and said at least one chemical are dispersed in air via a ventilation system.

12. The system of claim 10 wherein said detector is installed proximate to an air ventilator of said ventilation system.

13. The system of claim 10 wherein said heating unit is utilized for heating a building.

14. The system of claim 10 wherein:
said leakage of said refrigerant and said at least one chemical are dispersed in air via a ventilation system; and
said detector is installed proximate to an air ventilator of said ventilation system.

15. The system of claim 13 wherein:
said leakage of said refrigerant and said at least one chemical are dispersed in air via a ventilation system; and
said detector is installed proximate to an air ventilator of said ventilation system.

16. A system for detecting a leakage of a refrigerant and/or at least one chemical in an air conditioning and heating system, said system comprising:
a heating unit that interacts with an evaporator and a ventilation system;
a condenser that interacts with an expansion valve and a compressor and a reverse valve; and
a detector for detecting said leakage of said refrigerant and/or said at least one chemical dispersed in air through said ventilation system, wherein said refrigerant may be accidentally heated by a heating unit to produce said at least one chemical.

17. The system of claim 16 wherein said detector is positioned at a location proximate to said heating unit and said ventilation system.

18. The system of claim 16 wherein said refrigerant comprises Freon.

19. The system of claim 16 wherein said at least one chemical comprises chlorine as a byproduct of said refrigerant.

20. The system of claim 16 wherein said at least one chemical comprises hydrochloric acid as a byproduct of said refrigerant.

21. The system of claim 16 wherein said at least one chemical comprises phosgene as a byproduct of said refrigerant.
